(19) United States
(12) Patent Application Publication
(10) Pub. No.: US 2025/0176497 A1
(43) Pub. Date: Jun. 5, 2025

(54) WEARABLE DEVICE FOR ANIMALS WITH MULTIPLE COMMUNICATION CHANNELS ALLOWING BOTH REMOTE AND LOCAL CONTROL AND METHOD THEREFOR

(71) Applicant: HALTER USA INC, San Francisco, CA (US)

(72) Inventors: Jonathan CLARK, Auckland (NZ); Ruan NEL, Auckland (NZ)

(73) Assignee: HALTER USA INC, San Francisco, CA (US)

(21) Appl. No.: 19/042,700

(22) Filed: Jan. 31, 2025

Related U.S. Application Data
(63) Continuation of application No. PCT/IB2023/057605, filed on Jul. 27, 2023.

(30) Foreign Application Priority Data
Aug. 1, 2022 (NZ) 790929

(51) Int. Cl. A01K 11/00; A01K 15/02; A01K 27/00; H01Q 1/27; H04W 88/04

(52) U.S. Cl. CPC A01K 11/008; A01K 15/029; A01K 27/009; H01Q 1/273; H04W 88/04

(57) ABSTRACT

An animal wearable device and system therefor to virtually fence and/or guide animals. Where the wearable device is configured to utilise multiple communication protocols should one communication protocol fail or be more desirable to use. The wearable devices are further configured to reconfigure themselves to pass on received messages to nearby wearable devices through one of the multiple communication protocols.

### CROSS-REFERENCE TO RELATED APPLICATIONS

This application is a by-pass continuation of PCT/IB2023/057605, filed 7 Jul. 2023, which claims priority to New Zealand Patent Application No. 790929, filed on 1 Aug. 2022, both of which are incorporated herein by reference in their entireties.

### TECHNICAL FIELD

The present invention relates to a wearable device virtually fence and/or guide animals. More particularly but not exclusively, it relates to a wearable device configured to utilise multiple communication protocols should one communication protocol fail and further reconfigure itself to pass on received messages to nearby wearable devices.

### BACKGROUND OF THE INVENTION

Guiding of animals, in particular animals such as beef or dairy cattle between two locations, or restraining said animals within an area, using a wearable apparatus that is capable of administering a stimulus and controlled from a remote location, is known. An example of this technology is described in the PCT application WO2019180623A1 by Halter USA Inc. This technology utilises some form of long-range communication protocol to communicate with the wearable apparatus.

An issue with some aspects of this technology is that if communication to the collars from a remote location is lost or broken, then the wearable apparatus will not be able to be controlled.

NoFence from Batnfjordsøra, Norway commercialises a collar configured to be worn by an animal. The collar is remotely controlled over a cellular (GSM) communication protocol. The collar can restrain an animal within an area. If the collar loses connection with the cellular network, the collar can be communicated with via Bluetooth® from a mobile phone to send an instruction to the collar to remove the current restraint. A potential problem with this technology is that for herds of multiple animals, communication with each collar may take a long time. J. G. Panicker, M. Azman and R. Kashyap, “A LoRa Wireless Mesh Network for Wide-Area Animal Tracking,” 2019 IEEE International Conference on Electrical, Computer and Communication Technologies discloses, at a high level, a number of LoRa mesh network configurations, including a mesh network of LoRa nodes communicating with a LoRa Gateway Router connected to the internet. A potential problem with this technology is that if a gateway fails, communication to the nodes is not possible locally or remotely.

### OBJECT OF THE INVENTION

It is an object of the present invention to provide a wearable device that overcomes or at least partially ameliorates some of the abovementioned disadvantages or which at least provides the public with a useful choice.

### SUMMARY OF THE INVENTION

In the first aspect, the invention resides in a system comprising:
a first control apparatus configured to operate at least a first communication channel to send and receive animal guidance information;
a secondary control apparatus configured to operate at least a second communication channel to send and receive animal guidance information;
a wearable device comprising:
   one or more electronic devices configured to operate at least one function of the wearable device;
   a first communication device configured for use with the first communication channel to receive and transmit animal guidance information;
   a second communication device configured for use with the second communication channel to receive animal guidance information;
   a processor configured to:
      selectively operate at least the second communication device;
      determine an availability status of the first communication channel, and
         when available: operate the first communication device to receive animal guidance information from the first control apparatus; and
         when not available: operate the second communication device or receive animal guidance information from the secondary control apparatus; and
   selectively operate the one or more electronic devices based on the received animal guidance information.

In one embodiment, the system further comprises a plurality of wearable devices, wherein each wearable device comprises status data indicative of:
a first (master) status wherein the processor is configured to:
   receive animal guidance information from the second communication device; and
   operate the first communication device to transmit the animal guidance information received from the second communication device to another wearable device;
a second (slave) status wherein the processor is configured to:
   receive animal guidance information from:
      a wearable device having a first status; and/or
      the first control apparatus.

In one embodiment, the processor is configured to selectively operate the second communication device according to an operational duty cycle based on the determination of the first communication channel being unavailable.

In one embodiment, the operational duty cycle comprises a period of time where the second communication device is active, and a longer period of time where the second communication device is inactive.

In one embodiment, the status data is configured by the first control apparatus, secondary control apparatus, and/or a wearable device.

In one embodiment, the status data of a wearable device is configured as the first (master) status, from the plurality of wearable devices, based on one or more of:
the wearable device having a battery power surplus;
the wearable device in a geographical target area;
the wearable device first to connect with the secondary control apparatus.

In one embodiment, the first control apparatus is geographically fixed.

In one embodiment, the first control apparatus comprises a server backend system and radio communications gateway.

In one embodiment, the first communication channel is a LoRa wireless radio channel.

In one embodiment, the first communication channel is based on one of radio, LoRa, cellular, Wi-Fi, or other long-range communication protocol.

In one embodiment, the secondary control apparatus is portable.

In one embodiment, the secondary control apparatus is a smartphone.

In one embodiment, the second communication channel is a BlueTooth radio channel.

In one embodiment, the second communication channel is Bluetooth®, Bluetooth Low Energy, Near-field communication (NFC), Wi-Fi, Infrared, Ultra-Wideband and Zig-Bee.

In one embodiment, the primary control apparatus and secondary control apparatus are further configured to operate a third communication channel to send and receive guidance information.

In one embodiment, the first communication device is a long-range radio transceiver relative to the second communication device.

In one embodiment, the second communication device is a high power consumption device relative to the second communication device.

In one embodiment, the first communication device of slave status wearable device sends an acknowledgement message to the master wearable device to acknowledge receiving the animal guidance information.

In one embodiment, the second communication device of master status wearable device sends an acknowledgement message to the secondary control apparatus to acknowledge receiving the animal guidance information.

In one embodiment, the electronic devices comprise one or more of: a GPS, an IMU, a light, a sound source, memory components, one or more stimulus devices configured to deliver animal guidance commands, one or more stimulus devices, and a battery.

In one embodiment, the one or more stimulus devices are one or selected from, a vibrator configured to apply vibration to the animal, an electrode configured to apply an electric pulse to the animal, and a speaker or piezo configured to apply a sound to the animal.

In one embodiment, the third communication channel is on a cellular frequency.

In one embodiment, the wearable devices are worn by animals.

In one embodiment, the wearable devices are collars.

In one embodiment, the animal guidance information comprises one or more of:
disabling collar(s) from applying stimulus to the animal;
enabling collar(s) so they can apply a stimulus to the animal;
cancelling a break (virtual fence) boundary;
setting a break (virtual fence) boundary;
shifting the animal or herd, via applying one or more stimuli to one or more animals;
future breaks (virtual fences) for the herd or animal to be shifted to;
drafting the animal from the herd;
enabling data recording;
disabling data recording;
turning off the collar;
turning on the collar;
lighting an LED on the collar;
playing a sound or particular stimulus on the collar;
requesting upload from the collar of particular animal behaviour data;
requesting recording by the collar of particular animal behaviour data;
applying power saving modes so the collar uses less power;
full local control (i.e from the secondary control apparatus) and guidance
   of herd, and/or
   of individual animals;
guiding of the herd or the animal to follow the location of the secondary control apparatus;
firmware updates or changes to the control function or operation of any electronic devices housed or comprised by the wearable device; and/or
bit masking information.

In a second aspect, the invention relates to a wearable device comprising:
one or more electronic devices configured to operate at least one function of the wearable device;
a first communication device configured to communicate with a first control apparatus via a first communication channel to send and receive animal guidance information;
a second communication device configured to communicate with a secondary control apparatus via a second communication channel to send and receive animal guidance information;
a processor configured to:
   selectively operate at least the second communication device;
   determine an availability status of the first communication channel, and
      when available: operate the first communication device to send or animal guidance information from the first control apparatus; and
      when not available: operate the second communication device to send or receive animal guidance information from the secondary control apparatus; and
   selectively operate the one or more electronic devices based on the received animal guidance information

In one embodiment, the device further comprises status data indicative of:
a first (master) status wherein the processor is configured to:
   receive animal guidance information from the second communication device; and
   operate the first communication device to transmit the animal guidance information received from the second communication device to another wearable device;
a second (slave) status wherein the processor is configured to:
   receive animal guidance information from:
      a wearable device having a first status; and/or
      the first control apparatus.

In one embodiment, the first control apparatus is geographically fixed.

In one embodiment, the first control apparatus comprises a server backend system and radio communications gateway.

In one embodiment, the first communication channel is a LoRa wireless radio channel.

In one embodiment, the first control apparatus comprises a LoRa gateway.

In one embodiment, the first communication channel is based on one of radio, LoRa, cellular, Wi-Fi, or other long-range communication protocol.

In one embodiment, the secondary control apparatus is portable.

In one embodiment, the secondary control apparatus is a smartphone.

In one embodiment, the second communication channel is a BlueTooth radio channel.

In one embodiment, the second communication channel comprises one of Bluetooth®, Bluetooth Low Energy, Near-field communication (NFC), Wi-Fi, Infrared, Ultra-Wideband and Zig-Bee.

In one embodiment, the first control apparatus and secondary control apparatus are further configured to operate a third communication channel to send and receive guidance information.

In one embodiment, the third communication channel is on a cellular frequency.

In one embodiment, the first communication device is a long-range radio transceiver relative to the second communication device.

In one embodiment, the second communication device is a high power consumption device relative to the second communication device.

In one embodiment, the electronic devices comprise one or more of: a GPS, an IMU, a light, a sound source, memory components, one or more stimulus devices configured to deliver animal guidance commands, one or more stimulus devices, and a battery.

In one embodiment, the one or more stimulus devices are one or selected from, a vibrator configured to apply vibration to the animal, an electrode configured to apply an electric pulse to the animal, and a speaker or piezo configured to apply a sound to the animal.

In one embodiment, the wearable devices are worn by animals.

In one embodiment, the wearable devices are collars.

In one embodiment, the wearable devices are configured to be worn by an animal.

In one embodiment, the wearable devices are configured to virtually fence the animals.

In one embodiment, the animal guidance information comprises one or more of:
disabling collar(s) from applying stimulus to the animal;
enabling collar(s) so they can apply a stimulus to the animal;
cancelling a break (virtual fence) boundary;
setting a break (virtual fence) boundary;
shifting the animal or herd, via applying one or more stimuli to one or more animals;
future breaks (virtual fences) for the herd or animal to be shifted to;
drafting the animal from the herd;
enabling data recording;
disabling data recording;
turning off the collar;
turning on the collar;
lighting an LED on the collar;
playing a sound or particular stimulus on the collar;
requesting upload from the collar of particular animal behaviour data;
requesting recording by the collar of particular animal behaviour data;
applying power saving modes so the collar uses less power;
full local control (i.e from the secondary control apparatus) and guidance
   of herd, and/or
   of individual animals;
guiding of the herd or the animal to follow the location of the secondary control apparatus;
firmware updates or changes to the control function or operation of any electronic devices housed or comprised by the wearable device; and/or
bit masking information.

In one embodiment, a plurality of wearable devices are configured to operate the first and/or second communications device to facilitate a communication channel with one or more other wearables devices and thereby form a mesh network.

In one embodiment, the mesh network is sent the animal guidance information via either the first control apparatus or secondary control apparatus.

In one embodiment, the processor configures the respective wearable device as a slave device if the processor cannot receive animal guidance information from the first control apparatus or secondary control apparatus.

In one embodiment, the processor configures the respective wearable device as a slave device if the processor receives animal guidance information from another wearable device.

In a third aspect the invention relates to a system comprising:
a first control apparatus configured to operate at least a first communication channel to send and receive animal guidance information;
a plurality of wearable devices, each comprising:
   one or more electronic devices configured to operate at least one function of the wearable device; including a first communication device configured to receive and transmit animal guidance information;
   a processor configured to:
      selectively operate the one or more electronic devices based on the
   received animal guidance information and based on a device status parameter including a master and slave status;
wherein the processor of a wearable device configured as a master status device is further configured to:
   operate the first communication device to receive animal guidance information from the first control apparatus;
   operate the first communication device or a second communication device to transmit the animal guidance information received from the first second communication device to a slave wearable device; and
wherein the processor of a wearable device configured as a slave wearable device is further configured to:
   operate the first communication device to receive animal guidance information from the master wearable device apparatus.

In one embodiment, the master status wearable device is distinguished from a slave wearable device based on one or more characteristics comprising:
the wearable device having a battery power surplus;
the wearable device is in a geographical target area; and
the wearable device first to connect with the secondary control apparatus.

In one embodiment, the first control apparatus is a LoRa gateway.

In one embodiment, the wearable devices are configured to be worn by an animal.

In one embodiment, the wearable devices are configured to virtually fence the animals. in one embodiment, the first communication device is a LoRa transceiver.

In one embodiment, the second communication device is a short-range communication device.

In one embodiment, a secondary control apparatus is configured to operate the second communication channel to send and receive animal guidance information with the second communication device.

In one embodiment, the master status wearable device is distinguished from a slave wearable device based on the wearable device first to connect with the secondary control apparatus.

In one embodiment, the secondary control apparatus is a mobile phone.

In one embodiment, the wearable devices form a mesh network.

In one embodiment, the mesh network is sent the animal guidance information with via either the first control apparatus or secondary control apparatus.

In one embodiment, the processor configures the respective wearable device as a slave device if the processor cannot receive animal guidance information from the first control apparatus or secondary control apparatus.

In one embodiment, the processor configures the respective wearable device as a slave device if the processor receives animal guidance information from another wearable device.

In one embodiment, the animal guidance information is as described in the above aspects of the invention.

In one embodiment, the wearable device is as described in the above aspects of the invention.

In one embodiment, the first control apparatus is geographically fixed.

In one embodiment, the first control apparatus comprises a server backend system and radio communications gateway.

In one embodiment, the first communication channel is a LoRa wireless radio channel. In one embodiment, the first control apparatus comprises a LoRa gateway.

In one embodiment, the first communication channel is based on one of radio, LoRa, cellular,

Wi-Fi, or other long-range communication protocol.

In one embodiment, the secondary control apparatus is portable.

In one embodiment, the secondary control apparatus is a smartphone.

In one embodiment, the second communication channel is a BlueTooth radio channel.

In one embodiment, the second communication channel comprises one of Bluetooth®,

Bluetooth Low Energy, Near-field communication (NFC), Wi-Fi, Infrared, Ultra-Wideband and Zig-Bee.

In one embodiment, the first control apparatus and secondary control apparatus are further configured to operate a third communication channel to send and receive guidance information.

In one embodiment, the third communication channel is on a cellular frequency.

In one embodiment, the first communication device is a long-range radio transceiver relative to the second communication device.

In one embodiment, the second communication device is a high power consumption device relative to the second communication device.

In one embodiment, the electronic devices comprise one or more of: a GPS, an IMU, a light, a sound source, memory components, one or more stimulus devices configured to deliver animal guidance commands, one or more stimulus devices, and a battery.

In one embodiment, the one or more stimulus devices are one or selected from, a vibrator configured to apply vibration to the animal, an electrode configured to apply an electric pulse to the animal, and a speaker or piezo configured to apply a sound to the animal.

In one embodiment, the animal guidance information comprises one or more of:
disabling collar(s) from applying stimulus to the animal;
enabling collar(s) so they can apply a stimulus to the animal;
cancelling a break (virtual fence) boundary;
setting a break (virtual fence) boundary;
shifting the animal or herd, via applying one or more stimuli to one or more animals;
future breaks (virtual fences) for the herd or animal to be shifted to;
drafting the animal from the herd;
enabling data recording;
disabling data recording;
turning off the collar;
turning on the collar;
lighting an LED on the collar;
playing a sound or particular stimulus on the collar;
requesting upload from the collar of particular animal behaviour data;
requesting recording by the collar of particular animal behaviour data;
applying power saving modes so the collar uses less power;
full local control (i.e from the secondary control apparatus) and guidance
   of herd, and/or
   of individual animals;
guiding of the herd or the animal to follow the location of the secondary control apparatus;
firmware updates or changes to the control function or operation of any electronic devices housed or comprised by the wearable device; and/or
bit masking information.

In one embodiment, a plurality of wearable devices are configured to operate the first and/or second communications device to facilitate a communication channel with one or more other wearables devices and thereby form a mesh network.

In one embodiment, the mesh network is sent the animal guidance information via either the first control apparatus or secondary control apparatus.

In one embodiment, the processor configures the respective wearable device as a slave device if the processor cannot receive animal guidance information from the first control apparatus or secondary control apparatus.

In one embodiment, the processor configures the respective wearable device as a slave device if the processor receives animal guidance information from another wearable device.

Other aspects of the invention may become apparent from the following description which is given by way of example only and with reference to the accompanying drawings.

In this specification where reference has been made to patent specifications, other external documents, or other sources of information, this is generally for the purpose of providing a context for discussing the features of the invention. Unless specifically stated otherwise, a reference to such external documents is not to be construed as an admission that such documents, or such sources of information, in any jurisdiction, are prior art, or form part of the common general knowledge in the art.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary.

It is also to be understood that the specific devices illustrated in the attached drawings and described in the following description are simply exemplary embodiments of the invention. Hence, specific dimensions and other physical characteristics related to the embodiments disclosed herein are not to be considered as limiting.

It is acknowledged that the term “comprise” may, under varying jurisdictions, be attributed with either an exclusive or an inclusive meaning. For the purpose of this specification, and unless otherwise noted, the term ‘comprise’ shall have an inclusive meaning, allowing for inclusion of not only the listed components or elements, but also other non-specified components or elements. The terms ‘comprises’ or ‘comprised’ or ‘comprising’ have a similar meaning when used in relation to the system or to one or more steps in a method or process.

As used hereinbefore and hereinafter, the term “and/or” means “and” or “or”, or both.

As used hereinbefore and hereinafter, “(s)” following a noun means the plural and/or singular forms of the noun.

When used in the claims and unless stated otherwise, the word ‘for’ is to be interpreted to mean only ‘suitable for’, and not for example, specifically ‘adapted’ or ‘configured’ for the purpose that is stated.

For the purposes of this specification, the term “plastic” shall be construed to mean a general term for a wide range of synthetic or semisynthetic polymerization products, and generally consisting of a hydrocarbon-based polymer.

For the purpose of this specification, where method steps are described in sequence, the sequence does not necessarily mean that the steps are to be chronologically ordered in that sequence, unless there is no other logical manner of interpreting the sequence.

The entire disclosures of all applications, patents and publications, cited above and below, if any, are hereby incorporated by reference.

### BRIEF DESCRIPTION OF THE DRAWINGS

Preferred embodiments of the invention will be described by way of example only and with reference to the drawings, in which:

FIG. 1: shows a device and system and the multiple communications channels.

FIG. 2: shows an animal and device.

FIG. 3: shows a diagram of information that may comprise guidance information operable to direct an animal to, or contain an animal within, a desired location.

FIG. 4: shows a schematic diagram of particular (but not exclusive) electronics devices of the wearable device which are functionally required by some embodiments discussed herein.

FIG. 5: shows a diagram of an exemplary embodiment of the system where there is a primary control apparatus, and a secondary control apparatus.

FIG. 6: shows a diagram of one exemplary system configuration where a first wearable device is configured as a master device and the processor of that master device is configured to operate both the first and second communication devices to thereby connect with the primary and secondary control apparatus.

FIG. 7: shows a diagram of another exemplary system configuration where the communication channel with the primary control apparatus is unavailable.

FIG. 8: shows a diagram of another exemplary system configuration where the second communication channel with the secondary control apparatus is unavailable.

FIG. 9: shows a general control process of enabling local control.

FIG. 10: shows a farm-specific control process of enabling local control

FIG. 11: shows a general control process of disabling local control.

FIG. 12: shows a farm-specific control process of disabling local control via the backend.

FIG. 13: shows an alternative farm-specific control process of disabling local control via the secondary control apparatus.

### DETAILED DESCRIPTION

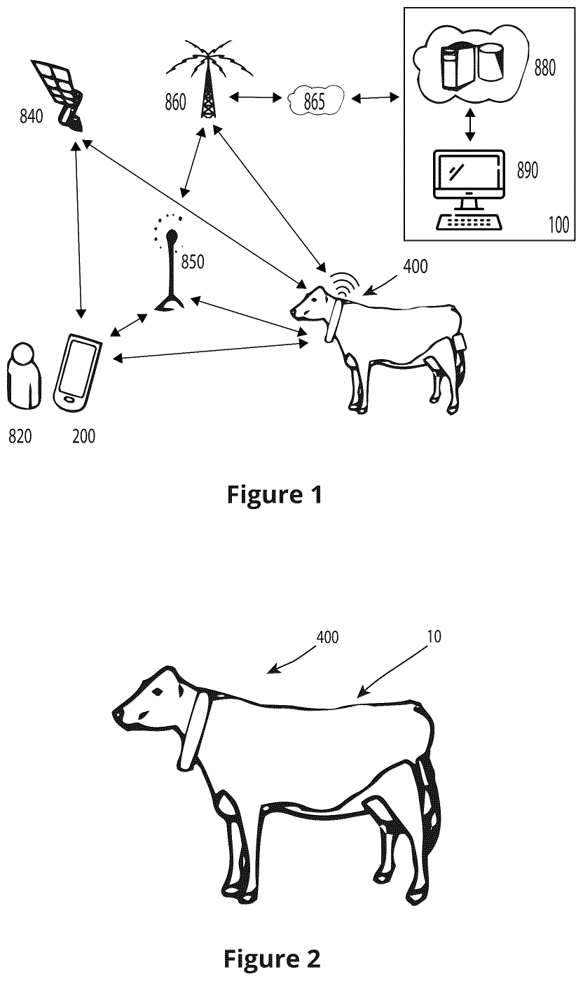

With reference to the above drawings, in which similar features are generally indicated by similar numerals, FIG. 1 illustrates a general system according to a first preferred embodiment of the invention and adapted for animal guidance. The present invention comprises a wearable device 400 configured to be worn by an animal 10. Such an animal 10 may be any of dogs, pets, dairy cows, beef animals, Bovidae, goat, bison, sheep, bull, lama or any other animal that is desired to be tracked, communicated with, ‘moved’, ‘shifted’, ‘drafted’, and/or ‘guided’. The invention is particularly useful to cattle that primarily feed on pasture or crops within paddocks. The animal 10 may form part of a herd of animals where one or more animals 10 in the herd wear a device 400. In this specification, the wearable device is implemented as a collar, i.e. for placement around the neck of an animal. Many placements and appropriate implementations are possible and the most suitable location will be dependent on the particular animal and environment for use.

The wearable device 400 utilises technology by the company HALTER® and is further described in patent publications WO2019180624 and WO2019180623. The HALTER® technology is capable of restraining an animal in a paddock defined by a virtual boundary, as well as being able to shift the animal from one location to another such as from a paddock to a milking shed. The wearable device 400 achieves this via administering audible signals to the left and/or right ears of the animal 10, and/or in combination with administering vibration and/or electrical stimulus to the animal 10. The wearable device 400 utilises electronics and/or software to control stimuli using control actions, as well as to communicate externally-such as to receive target locations, transition locations etc.

The herein described animal guidance functions are provided by a control system which may herein be referred to as operations of a controller. The controller is implemented by one or more computing devices which form the architecture of a system configured to perform desired functions. Reference to “controller” may refer to one or more electronic devices that are configured to directly or indirectly communicate with, or over, one or more networks. A computing device may be a mobile device. As an example, a mobile device may include a smart wearable device such as a wearable animal collar (or “collar”), a cellular phone, IoT capable device, smartphone, a portable computer, such as watches, glasses, lenses, clothing, and/or the like, and/or other like devices. In other non-limiting embodiments, the computing device may be a desktop computer or other non-mobile computer. Furthermore, the term “computer” may refer to any computing device that includes the necessary components to receive, process, and output data, and normally includes a display, a processor, a memory, an input device, and a network interface.

Any or a selection of computing devices is configured to communicate with any other computing device as desired, where the terms “communication” and “communicate” may refer to the reception, receipt, transmission, transfer, provision, and/or the like of information, such as data, signals, messages, instructions, commands, and/or the like. For one controller, such as a device, a system, a component of a device or system, combinations thereof, and/or the like to be in communication with another controller means that the one controller is able to directly or indirectly receive information from and/or transmit information to the other controller. This may refer to a direct or indirect connection that is wired and/or wireless in nature. Additionally, two controllers may be in communication with each other even though the information transmitted may be modified, processed, relayed, and/or routed between the first and second controller. For example, a first controller may be in communication with a second controller even though the first unit passively receives information and does not actively transmit information to the second unit. As another example, a first controller may be in communication with a second controller and at least one intermediary controller, where a third controller is located between the first controller and the second controller, processes information received from the first controller and communicates the processed information to the second controller. In some non-limiting embodiments, data or information may refer to a network packet such as a data packet, and/or the like that includes data. It will be appreciated that numerous other arrangements are possible.

Further, in some embodiments, there is a central or master controller which may be referred to as a server, or generally as ‘the controller’. The term server or controller may refer to or include one or more processors or computing devices, storage devices, or similar computer arrangements that are operated by or facilitate communication and processing for multiple parties in a network environment, although it will be appreciated that communication may be facilitated over one or more public or private network environments and that various other arrangements are possible. Further, multiple computers such as servers or other computerised devices, directly or indirectly communicating in the network environment may constitute the controller such as a computing device configured for central service control.

Reference to “a server” or “a processor,” as used herein, may refer to a previously-recited server and/or processor that is recited as performing a previous step or function, a different server and/or processor, and/or a combination of servers and/or processors, and refer to general implementations of processors which form the functional elements of the controller. For example, a first server and/or a first processor that is recited as performing a first step or function may refer to the same or different server and/or a processor recited as performing a second step or function. Further, reference to a server or processor may refer to a group of servers or group of processors, each configured to perform a task. Such tasks may include processes or algorithms which are undertaken by one or more servers of processors. Tasks undertaken by any one or more processors, such as by an on-collar and/or off-collar processor, are therefore to be understood as tasks undertaken collectively by the controller or control system.

Embodiments of this disclosure include reference to cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Some embodiments are private clouds where the cloud infrastructure is operated solely for an organisation. Other embodiments are community clouds, where cloud infrastructure is shared by several organisations and supports a specific community that has shared concerns such as security requirements, policy, or compliance considerations. The community cloud may be managed by the organisations or a third party and may exist on-premises or off-premises. In some embodiments, a public cloud infrastructure is made available to the general public or a large industry group and is owned by an organisation selling cloud services. A cloud computing environment is service-oriented with a focus on statelessness, low coupling, modularity, and semantic interoperability. At the heart of cloud computing is an infrastructure comprising a network of interconnected nodes. The cloud computing models may be managed by the organisation or a third party and may exist on-premises or off-premises. One applicable implementation model for the present disclosure is by Software as a Service (Saas). SaaS is the capability provided to the consumer to use the provider's applications running on a cloud infrastructure. The applications are accessible from various client devices through a client interface such as a web browser. The consumer does not typically manage or control the underlying cloud infrastructure including network, servers, operating systems, storage, or even individual application capabilities.

Non-limiting embodiments or aspects of the present invention are directed to a method and system for controlling functions of a wearable animal collar which are operable to direct an animal to a target location. Accordingly, some embodiments relate to an animal guidance system operable to guide the animal to a target location.

In some embodiments described herein, the wearable device comprises a controller configured to operate functions of the wearable device, and the wearable device communicates with a computing device operating as a controller configured to manage control of the wearable device. The animal guidance system has a wearable device (collar) adapted to be worn by an animal as will be discussed in further detail below. However, the wearable apparatus has at least one stimulus device operable to administer at least one form of stimulus to the animal and guide the animal to the target.

The animal guidance system further has at least one positioning system configured to output animal position data and voiding target position data. The guidance system may be provided by a GPS device located on the wearable apparatus, or local positioning system. Many forms of the positioning system are possible, and some of which are discussed in further detail below.

The animal guidance system further has at least one animal activity sensing device configured to output animal activity data. Animal activity data typically includes data relating to the movement of an animal as defined by one or more sensors configured to generate a signal based on a change on any one or more degrees of freedom as may be desired. Further detail on animal activity data and interpretation of said data to indicate animal activity is discussed below.

The animal guidance system further has at least one controller module configured to undertake particular functional requirements. The specification below will discuss many functions in terms of desired outcomes, data and considerations to support those outcomes. It should be understood that for each outcome, the controller is configured to receive information, undertake any one or more functional steps based on the received information, and generate an output operable to achieve the stated outcome.

For example, in some embodiments, the controller is configured to receive the animal position data, receive the animal activity data, determine animal behaviour information from the animal position data and/or animal activity data; and generate an output operable to control at least one stimulus device to administer the stimulus to guide the animal to a target location.

In some embodiments, the controller is made up of several discrete processing devices, such as microprocessors or other equivalent forms of computing device, and collectively form a control system. Further, those processing devices are distributed over a variety of locations, and may be interconnected as a network. The processing devices of the network are connected, preferably wirelessly. A wearable animal apparatus may for example have a processor configured to receive and act on data from the animal positioning system and animal activity device. That data may be communicated via the network to one or more other processing devices.

In some embodiments, one of the processing devices acts as a master device that connects to any number of other devices, collates data from any one of the number of other devices, makes decisions based on that collated data, then communicates instructions to any one or more of the other processing devices. For example, in some embodiments, the controller has at least one master processing device connected to a number of other processing devices which are located on an animal wearable collar. In such embodiments, the master processing device acts as a first controller module part and the one or more on-collar processing devices acts as a second controller module part, the controller module parts acting together as the controller of the control system. In some embodiments, the controller of each wearable apparatus has control status data which defines where on a hierarchy of apparatus that particular apparatus is ordered. In exemplary embodiments, that status data includes data which defines the apparatus as a master, for determining and sending control decisions, and a slave, for receiving and acting on those control decisions.

In some embodiments, functions of the controller are enabled according to a SaaS subscription status.

In order for the animal to move to a target location, a controller configured to operate the wearable apparatus (also herein called a collar) must determine or be supplied with the target location. As such, the controller must determine at least the animal location and a target location, and any other used variables to output to the stimulus device a stimulus or stimuli to suggest movement to the animal to the target location.

In the preferred embodiment, the controller onboard the wearable apparatus is configured to receive a signal from an off-collar (off-wearable device) location relating to the target location. In some embodiments, the target location comprises a destination at the end of a pathway or heading. In some embodiments, the path between the target location contains one or more waypoints where the animal is desired to either pass through or exhibit some kind of behaviour when nearby. In further embodiments, the controller onboard the wearable device is configured to receive a signal from an off-collar (off-wearable device) location relating to the paddock or area that is to virtual restrain the animal within. The off-collar processor may be located in the cloud, on a remote PC, or on a user's computing device etc.

In other embodiments, the wearable device comprises the processor. In further embodiments, determination of the above information to be determined is on the processor of the wearable device, or on both the off-collar and on-collar processors. Within this specification, where calculations or determinations are required, it is assumed they are performed by the control system which comprises computation by an on-collar processor and/or an off-collar processor. For example, in some exemplary embodiments, activity and location information is determined by the on-collar processor, whereas the target location and stimulus controls may be determined by an off-collar processor. Other implementations are possible.

FIG. 1 is one example of a general communication system infrastructure diagram incorporating the features of the invention in an example where a position of a cow 10 in a field is being monitored and controlled. In this specification, geographical control of animals is performed with a wearable device 400. The wearable device operates to output stimuli that operate to guide an animal. Guidance of an animal is conducted with animal guidance information, and such information may include geographical boundary information, geographical target information and control operations, including stimuli output, which elicit movement of an animal to the target location, and many other animal guidance controls.

In this relatively simple example, a user 820 tracks the position of a cow 10 within a particular portion of the field and if deemed necessary or desirable, outputs guidance information which may cause the application of a desired form of stimulus to the cow to thereby elicit a response from the animal, such as guiding the animal to a new location.

The user 820 may use a software application (such as a mobile app) on mobile device 830 or PC 890, which includes, or can receive data from the internet. This software application, as well as any processors or server utilities in communication with the mobile device or PC, may be referred to as the “backend”. Again, the backend may be anything that communicates with the gateway, that is not on the collar side of the gateway. However, in most applications, the backend represents a computing device that is immobile. The server 880 and/or the PC 890 and/or the person's 820 user device 200 may, in some embodiments, be referred to as a first or primary transmission device operating a first transmission protocol to communicate with the wearable apparatus 400.

The wearable apparatus 400 can send and receive data from local wireless data transmission devices 850 (embodied as a tower). The transmission towers are configured to send and receive wireless communications, and in some cases, function as a gateway. The transmission towers 850 can send and receive information to cell towers or satellites to the internet to store data stored on a remote server, such as cloud server 880—i.e a backend. One preferred form of a transmission device 850 is a spread spectrum low-frequency RF transmitter. For example, as part of a LoRa transmission protocol system as will be explained with reference to a preferred embodiment below.

The wearable apparatus 400 is capable of detecting signals originating from one or more of GPS satellites 840, gateways 850 of the first communication protocol, short-range communications devices as discussed further below, and one or more cell towers 860, user devices 200 including short-range communication signals such as Bluetooth.

In some embodiments, the gateway is a Kona Macro IoT Gateway from Tektelic Communications. The Kona Macro IoT Gateway comprises both cellular modem and GPS antennas embedded internally. The Kona Macro IoT Gateway is targeted at network sites that dictate a small form factor and low power consumption. The gateway can communicate with the device(s) 400 as well as the backend.

By connecting with the Internet 865 via Wifi, Bluetooth, or cellular transmissions such as 3G, 4G, LTE and others, the software application may access the data stored on the remote server, such as cloud server 880. The data contained in the cloud server 880 can also be accessed by a processor of a computing device, such as a PC 890, via a connection through the Internet 865.

The PC 890 or a user device (such as mobile device 830) comprises a user interface and/or server 880, and for some embodiments, is configured to perform the control action on the basis of a control command. Preferably, the processors of the control system are operatively connected to or are part of a user device such as a smartphone, PDA, PC, laptop or any other suitable user device.

The user 820 may monitor the result of the comparison performed by a processor that is either part of, or is operatively connected to the collar 20, on a screen of the mobile device 830, and depending upon the result of the comparison, the user 820 may send an appropriate control command including animal guidance information. The control command may then be received by the collar processor which will then determine, according to the control command received, whether a control action is required. If the collar processor determines from a control command that no stimulus is to be applied to the animal 10, then no control signal will be transmitted or sent to the stimulus device of the collar 400. However, if the controller determines from a control command that a stimulus (such as a sound and/or vibration and/or an electric shock) is to be applied to the animal 10, then a control signal will be sent to the stimulus device to administer the appropriate stimulus to the animal 10.

Preferred embodiments include a position sensing system, or interface with a position sensing system that acts to locate animals and locations of interest within a consistent geographical frame of reference. The position sensing system operates to provide animal position data. The position sensing system further operates to provide a reference to any one or more locations. The position sensing system further operates to provide a relative frame of reference to the animal position data and the one or more locations.

In preferred embodiments, the controller is configured to receive or determine location information as described above, including the one or more locations of interest. The location information may be in the form of coordinate data. In some embodiments, the position sensing system is a local positioning system (LPS) or GPS. Each of the local or global positioning systems include one or more transmitter components that output location reference data, and a receiver component that receives the location reference data and determines a location of the receiver component relative to the reference data. For example, LPS transmitters may include one or more beacons such as cellular base stations, Wi-Fi access points, and radio broadcast towers to compute the position of the receiver/sensor.

Locating position information of an object with a GPS position sensor is previously known in the art and calculation of a position is performed by precisely timing the signals sent by GPS satellites high above the Earth. Each satellite may continually transmit messages that may include the time the message was transmitted, precise orbital information (the ephemeris), the general system health, and rough orbits of all GPS satellites (the almanac). The GPS sensor/receiver may use the messages it receives to determine the transit time of each message and compute the distance to each satellite. These distances along with the satellite locations may be used with the possible aid of trilateration, depending on which algorithm is used, to compute the position of the receiver/sensor, and therefore the animal attached to the receiver/sensor.

In preferred embodiments, animal position data is derived from a positioning system receiver attached to a collar worn by an animal and is configured to communicate LPS or GPS data to the controller to thereby indicate the animal position data.

In some embodiments, the controller is configured to determine the location of each animal wearing a collar. In such embodiments, the controller is configured to receive position data from a position sensing receiver located on each collar. For a herd of animals, the controller may thereby determine the location of each animal wearing a collar which includes a position sensing receiver. In some embodiments, the controller is configured to receive position data pertaining to one or more locations of interest within the geographical frame of reference. In some embodiments, the controller is configured to determine if a control action is required based on a comparison of at least one received position with other position data. The position data may include longitude, latitude, altitude, and/or horizontal position or coordinate data pertaining to the animal or other locations of interest.

FIG. 2 is an exemplary depiction of a wearable apparatus (collar) 400 worn by a cow 10. The collar 400 is a housing for numerous electronic components which perform or assist operation functions. The exemplary collar 400 has a positioning system such as a GPS unit; multiple wireless network communication radios operable to communicate on multiple radio frequencies according to multiple communication protocols; any number of animal movement sensors such as an IMU/accelerometer, gyroscope, compass or similar; and a processor.

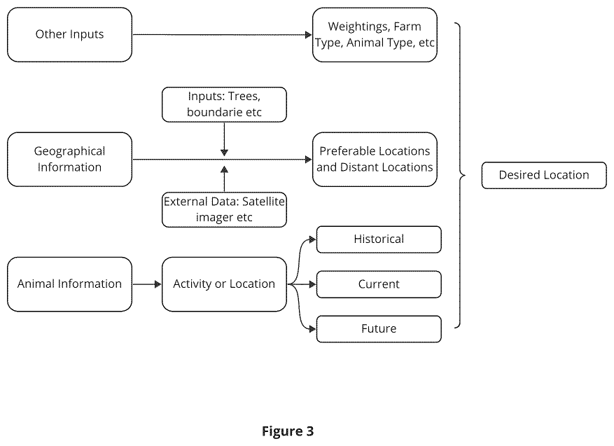

FIG. 3 shows a diagram of information which may comprise guidance information operable to direct an animal to, or contain an animal within a desired location. Guidance information may also include information derived from sensors on the wearable device 400 which are then communicated to the primary or secondary control apparatus for application in further determinations. Guidance information (also known as payload), as referred to elsewhere in this specification, may also include other data which may be communicated between the primary control apparatus and/or secondary control apparatus and/or a wearable device 400, including control outputs which may direct particular operation of any one or more electronic devices of the wearable device, or changes to any software stored for execution on the wearable device. The guidance information may include geographical target locations for the animals to be guided to, virtual fencing information defining a containment zone for an animal to be guided within, and/or pathway data indicating a path an animal is to be guided along. The guidance information may include or be based on animal data including animal activity of location data, historic animal location data, and future or desired animal location data. Any one or more of the depicted information modules may be communicated between the server and wearable device according to desired guidance functions of the system.

More specific examples of animal guidance information includes:
disabling collar(s) from applying stimulus to the animal;
enabling collar(s) so they can apply a stimulus to the animal;
cancelling a break (virtual fence) boundary;
setting a break (virtual fence) boundary;
shifting the animal or herd, via applying one or more stimuli to one or more animals;
future breaks (virtual fences) for the herd or animal to be shifted to;
drafting the animal from the herd;
enabling data recording;
disabling data recording;
turning off the collar;
turning on the collar;
lighting an LED on the collar;
playing a sound or particular stimulus on the collar;
requesting upload from the collar of particular animal behaviour data;
requesting recording by the collar of particular animal behaviour data;
applying power saving modes so the collar uses less power;
full local control (i.e from the secondary control apparatus) and guidance
   of herd, and/or
   of individual animals;
guiding of the herd or the animal to follow the location of the secondary control apparatus;
firmware updates or changes to the control function or operation of any electronic devices housed or comprised by the wearable device; and/or
bit masking information.

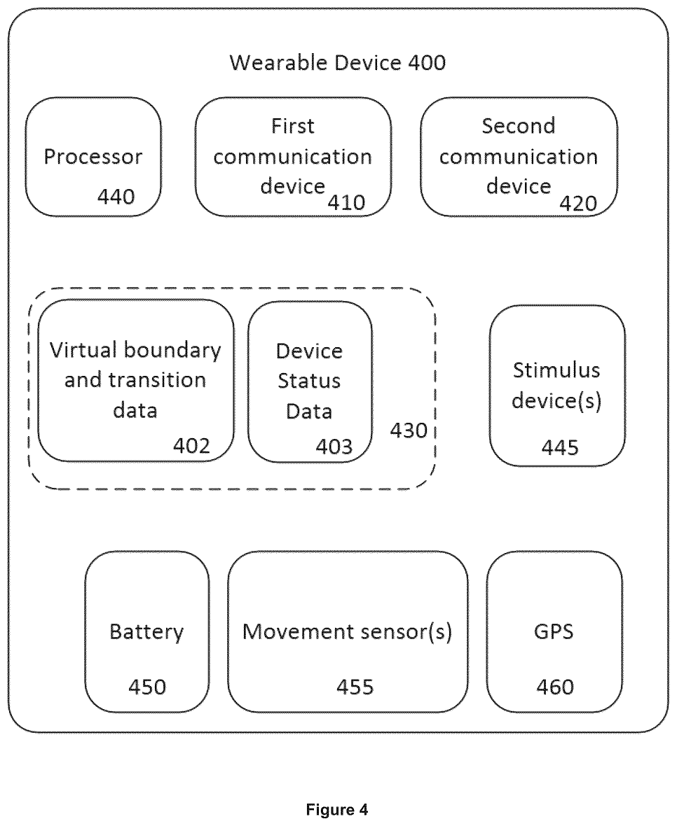

FIG. 4 shows a schematic diagram of particular (but not exclusive) electronics devices of the wearable device 400 which are functionally required by some embodiments discussed herein. The particular components comprise the above-mentioned processor 400; a first communications device 410; a second communications device 420; and a memory component 430 which is operable to store animal guidance data such as the aforementioned virtual boundary or transition data 402 and device status data 403. One or more stimulus devices 445 are typically included on the collar for enabling animal guidance controls. Stimulus devices include shock deployment electronics, light sounds and vibration output devices. A GPS 460 and one or more movement sensors 455 are typically included for the determination of animal location and movement. Movement sensors may include devices such as inertial measurement components, accelerometers, gyros, magnetometers, and environmental sensors such as moisture, temperature and humidity sensors. The processor 440 is connected to and configured for the control of the other components of the collar.

The wearable device may further comprise one or more antennae that operate to communicate radio signals from either the first or second communications device to and from the collar. A GPS antenna may also be integrated with the antennae of any one or more of the communications devices. For example, the antennae may comprise separate elements tuned for particular radio communication frequencies, or may have broadband or multiband elements such as combining GPS receiver with wireless network communication into a single package, and or for short-range communications.

In some embodiments, animal movement data is derived from the GPS signal. For example, a heading and speed can be derived from changing GPS coordinates; or acceleration data can be derived from changing GPS coordinates and thereby used to determine a change in speed and displacement. In some embodiments, the wearable device 400 contains an IMU configured to directly sense, for example, movement and heading data. Any number of IMU sensors may also be contained on the wearable device 400 for providing animal guidance data. Any combination of GPS and IMU-derived position and location data may be used by the controller as part of the deployment of guidance data or determinations of guidance data.

Power for the electronic devices of the wearable apparatus 400 is provided by a battery 450, preferably rechargeable. The battery is typically supported by a charging circuit and renewable energy source such as a solar panel. Particular operations to mitigate power consumption are discussed further below. Preferably the battery is rechargeable. Preferably the recharging power is provided by a solar or wireless power transfer device. However, in some embodiments, the battery is intended to be recharged by removal of the collar from the animal and connected to a source of charging power.

The limited power available from the battery makes power consumption an important consideration for the operation of collar functions. Particularly high current consumption devices include the first communications device 410 and a second communications device 420 which are typically radio transceiver devices. Management of transceiver operation, including using the most preferable transceiver at any one time, such that power is not consumed by both devices substantially simultaneously, is particularly important for minimising power consumption.

### First Communications Device 410

In preferred forms, the first communications device 410 is a radio transceiver or uses a radio signal in order to report the status of the apparatus (status data) and/or collar and/or to update a new area boundary, receive new instructions, receive commands, and/or other parameters such as the communication of guidance data.

The first communications device 410 is configured to communicate to the backend, and to other wearable devices 400 which may be in the communicable range.

One communication protocol of the first communications device 410 is a LoRa protocol. However, it is envisaged other long-range communication protocols may be used, such as WiFi, WiMAX, SigFox, LTE-M, DASH7, IEEE 802.11ah, CC430, NB-Iot etc.

In one embodiment, LoRa (from “long-range”) is the physical proprietary radio modulation technique used for communication between a locally situated communications tower 860 and the wearable devices 400. LoRa is based on spread-spectrum modulation techniques derived from chirp spread spectrum (CSS) technology. LoRa was developed by Cycleo (patent U.S. Pat. No. 9,647,718) and later acquired by Semtech.

LoRaWAN defines the software communication protocol and system architecture. LoRaWAN is a media access control (MAC) protocol for wide area networks. It is designed to allow low-powered devices to communicate with Internet-connected applications over long-range wireless connections. The continued development of the LoRaWAN protocol is managed by the open, non-profit LoRa Alliance, of which SemTech is a founding member.

The LoRaWAN network uses a centralised entity, called a gateway. LoRaWAN is based on a single-hop star topology. Where the gateway sends information packets to one or more nodes. In one example of this, the nodes are smart wearable devices carried by animals.

Internet of Things use cases, such as, smart cities, smart farms, agriculture, forestry, wildlife tracking etc often require spanning large areas. Sometimes tens, to hundreds, to thousands, of sensor nodes are deployed to support such use cases.

Typically, an IoT use case comprises severely resource-constrained devices-such as the wearable apparatus 400. Whereas the wearable apparatus 400 is constrained by power constraints, as it relies on solar power and a lightweight battery. Due to the power constraints, other established long-range technologies are not usable. LoRa offers long coverage, and reliability and can be used at very low power.

LoRaWAN is built as a star-of-stars topology, where the devices located in the defined area are able to send packets (data, information) to a gateway which is then responsible for forwarding those packages to the backend.

A front-end module (FEM) can be utilised between the transceiver of the long-range communications device and antenna to efficiently optimise both the transmission range and receiver sensitivity. A FEM integrates transmit power amplification, receive low noise amplification, antenna switching between the transmit and receive paths, and the required matching and filtering.

In one embodiment, the wearable device 400 comprises a 860 to 930 MHz RF Front-End Module from Skyworks. In particular, the wearable device 400 comprises a SKY66420-11. The SKY66420-11 is a high-performance, highly integrated RF front-end module designed for LPWAN—supporting LoRa®, SigFox and other unlicensed band technologies

For the purposes of illustrating embodiments, the first communications device 410 is to be considered “long range”, meaning that the usable range of wireless communications is further than that of the second communications device 420.

### Second Communication Device 420

In preferred forms, the second communications device 420 is a radio transceiver or uses a radio signal in order to report the status of the apparatus (status data) and/or collar and/or to update a new area boundary, receive new instructions, receive commands, and/or other parameters such as the communication of guidance data.

The second communications device 420 has short-range communication capabilities. Short-range communication capabilities include one or more of the following protocols, Bluetooth®, Bluetooth Low Energy, Near-field communication (NFC), Wi-Fi, Infrared, Ultra-Wideband and Zig-Bee.

The first and second radio transceivers are optimised for long and short-range communication respectively. Accordingly, it is preferable that the first transceiver communicates with a device located at a relatively long range, while it is also preferable that the second transceiver communicates with a device that is located at a relatively short range.

In preferred embodiments, the server of the system is the primary control apparatus and is configured to transmit guidance data to a wearable device using the transmission protocol of the first transceiver. However, if communication with the primary control apparatus is unavailable, for example, due to a failure at the server or communication hardware level, or other event causing the communications protocol to be unavailable.

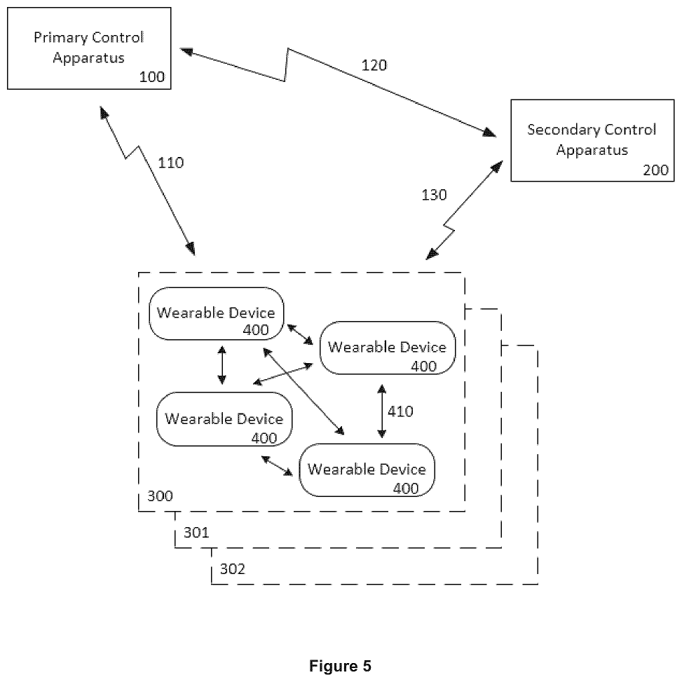

FIG. 5 shows a diagram of an exemplary embodiment of the system where there is a primary control apparatus 100, and a secondary control apparatus 200. Each of the primary and secondary control apparatus is selectively configured to communicate with one or more wearable devices 400. For example, one common scenario is that a group of wearable devices are contained in a small geographical area, in particular, where the cattle are adorned with a wearable device and contained within a virtual fenced perimeter 300. The primary control apparatus may further be configured to communicate with many other wearable devices 400 which may be in the same geographical location 300, or in separate locations 301, 302. Each wearable device 400 may further be configured to communicate 410 with other wearable devices within range of either the first or second communication protocol.

In the exemplary embodiment, the primary control apparatus 100 is configured to communicate with one or more wearable devices 400 via a first wireless communications channel 110, the channel being defined by a communication protocol and/or communication characteristics such as the wireless technology. The secondary control apparatus 200 is configured to communicate with one or more wearable devices via a second wireless communications channel 130, the channel being defined by a communication protocol and/or communication characteristics such as the wireless technology. Further, in some embodiments, the primary and secondary control apparatus are configured to communicate with one another via wired or wireless channel 120. The processor of each wearable device 400 is configured to selectively use the first and/or second communication channel based on one or more control criteria.

From time to time things break, and every now and again the things that break prevent the primary control apparatus 100, operating the first wireless communications channel 110, from being able to communicate with one or more wearable devices 400.

When a breakage happens, there can be negative implications for the welfare of the animal and the sentiment of the customer toward the use of the technology. In order to capture all potential breakage scenarios, control of each wearable apparatus needs to be transferred from the primary to the secondary control apparatus 200. In preferred embodiments, the secondary control apparatus 200 in the system is a portable handheld device such as a smartphone or other mobile personal computing device; and the second communications channel is a short-range wireless protocol such as Bluetooth. Bluetooth is particularly preferable due to its inclusion in most smartphone hardware. However, other technology protocols may be used to implement the channel as may be practical for inclusion on the wearable device and a portable device for use in the environment of the wearable devices.

In one embodiment, each wearable device 400 is configured to send and receive guidance-related information with the primary control apparatus 100, and if the primary communication link 110 between the wearable device is broken, revert to the use of the secondary communication link 130 with a secondary control apparatus 200.

Accordingly, each wearable device requires a determination of whether to communicate with the primary and secondary control apparatus. Further, where the wearable devices comprise a group of wearable devices, defined as being in communicable range with one another, each wearable device requires a determination of whether some or all wearable devices are to communicate with the primary, the secondary control apparatus, or both.

In one embodiment, the primary control apparatus is configured to periodically transmit a signal indicative of a channel status. The signal could be, for example, a short pulse transmitted at regular intervals and operable for receipt by each wearable device. The wearable device in turn is configured to receive the signal and expect the signal at that interval. If that signal were not received, the wearable device is configured to determine whether the primary communication channel is unavailable.

For example, a breakage causing the unavailability of the primary communication channel could be due to any one or more of, for example, the gateway down, or the backend down.

In one embodiment, each wearable device 400 comprises the device status data 403 which may be defined by either the wearable device itself, the primary control apparatus 100 or the secondary control apparatus 200. The device status data 400 comprises a determination of the status of the wearable device in relation to other wearable devices which may be in communicable range. In some embodiments, the device status data comprises one of a master status where one wearable device is configured to transmit guidance data and a slave status where the wearable device is configured to receive guidance information from a master wearable device.

### Master Device Status

In some embodiments, a wearable device with device status data specified as the master device has a processor 440 configured to operate the second communication device 420 to communicate with a secondary control apparatus 200.

In some embodiments, the processor is further configured to operate the first communication device 410 to communicate with one or more other wearable devices in the communicable range.

For example, a master device status wearable device acts as a communication node between the second communication device 420 using the second communication channel, and other wearable devices in the communicable range of the first communication channel. It is preferable that only one wearable device is configured as a master status device at any one time and thereby define a communication hierarchy that avoids confusion, or at least only one wearable device in the communicable range of the first communication channel such that a communication hierarchy is established in a particular area.

### Slave Device Status

In some embodiments, a wearable device with device status data specified as a slave device has a processor 440 configured to operate the first communication device 410 to communicate with one or more other wearable devices in the communicable range.

Furthermore, in exemplary embodiments, slave device status devices are configured to receive guidance information from either a master status device, or directly from the primary or secondary control apparatus. The slave device status is considered the default status configuration of a wearable during regular operation, whereas one master status device is intended to act as the communication node for those slave device status devices.

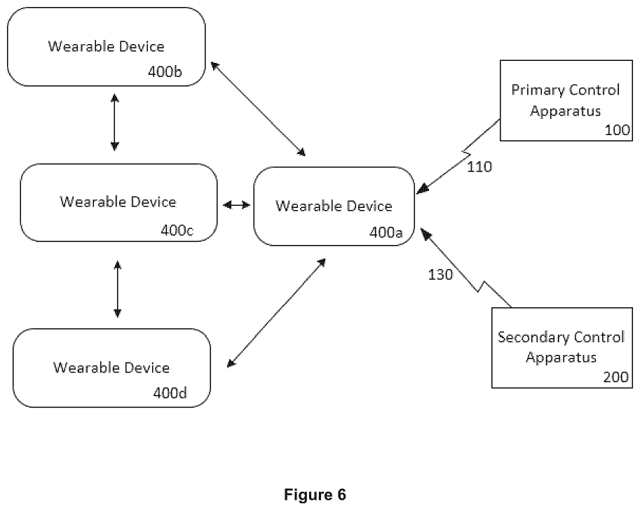

FIG. 6 shows a diagram of one exemplary system configuration where a first wearable device 400a is configured as a master device and the processor of that master device is configured to operate both the first and second communication devices to thereby connect with the primary and secondary control apparatus. Further, the remaining wearable devices in group 400b,c,d are configured as slave devices, and as such, are configured to operate the primary communication device. Communication between all devices 400a,b,c,d is facilitated by the primary communication device 410 of each wearable device. The depicted system configuration provides for the primary and/or secondary control apparatus to communicate guidance information to the wearable device 400a having the master status. The wearable device 400a then acts as a node to facilitate communication with other wearable devices in the group.

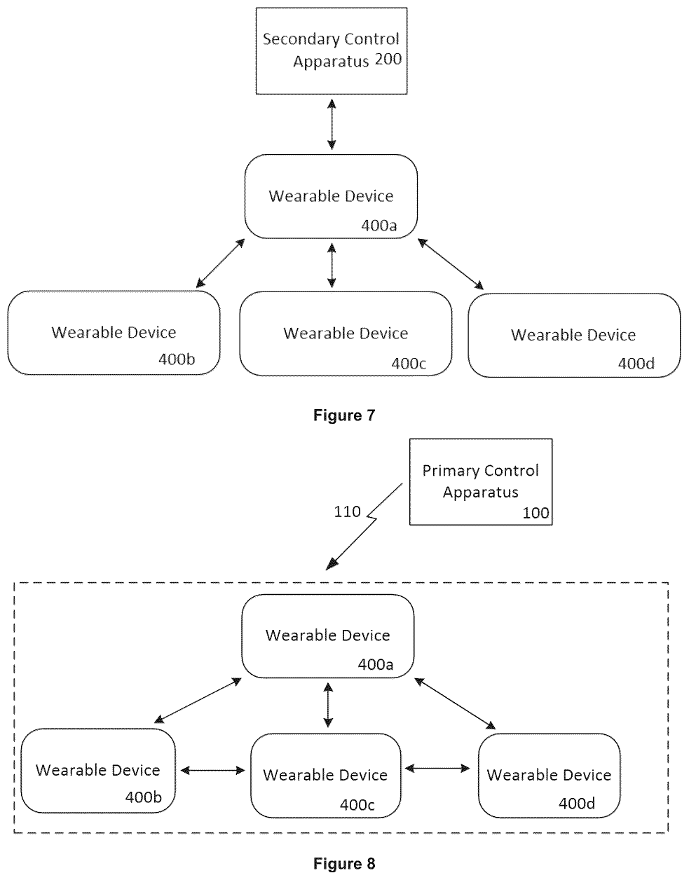

FIG. 7 shows a diagram of another exemplary system configuration where the communication channel with the primary control apparatus 100 is unavailable. As such, the first wearable device 400a is configured as a master device that communicates with the secondary control apparatus 200 via the secondary communication device 420 and the secondary communication channel. As described with reference to FIG. 6, the master status device 400a is configured to communicate with other wearable devices 400b,c,d via the primary communication device 410.

FIG. 8 shows a diagram of another exemplary system configuration where the second communication channel with the secondary control apparatus 200 is unavailable. A wearable device 400a is configured as a master device and the remaining wearable devices in the group 400b,c,d are configured as slave devices. Communication between all devices 400a,b,c,d is facilitated by the primary communication device of each wearable device. The depicted configuration may be preferable in some circumstances where it is desirable to have one wearable device acting as a master node for communication to other wearable devices in the communicable range. For example, the master status wearable device 400a may be a node located in between a gateway and a distant group of other wearable devices, and therefore acting in a manner similar to a radio repeater node.

### Setting Device Status-Manual Set Devices

In some embodiments, the primary control apparatus is configured to determine and set the status of each wearable device. As mentioned, under ordinary animal guidance operation, each wearable device is configured as a slave device. However, there may be a requirement for either the primary or secondary control apparatus to determine the status of any one or more devices. As such, in one embodiment, the primary and/or secondary control apparatus are configured to output a signal operable to configure the status of any one or more wearable devices which are in the communicable range to be a master status device. In some embodiments, the master status device is configured to operate the second communication device 420 to facilitate communication with the secondary control apparatus and/or the primary control apparatus.

In some embodiments, the system is configured to set the status of a wearable device with the first (master) status based on one or more of the wearable devices having a battery power surplus, the wearable device in a geographical target area and/or the wearable device first to connect with the secondary control apparatus.

### Setting Device Status-Auto-Set Devices

When the first communication link 110 is lost, or the primary to secondary communication channel 120 is unavailable, there is required to be other means to configure the device status of one or more wearable devices such that animal guidance functions are able to be communicated to each wearable device.

For example, a farmer may want to control animals by directing guidance information to be transmitted to the wearable devices by operating their secondary control apparatus 200. To do this, the secondary control apparatus 200 requires a communication channel 120 with the primary control apparatus, typically facilitated by an internet connection. However, if the internet connection is unavailable (facilitating the primary to secondary communication channel 120), the farmer is unable to control the transmission of guidance information via the gateway to the wearable devices.

Therefore there are two scenarios in which the status of the wearable device may be automatically set:
1. The first scenario is where the first communication channel 100 is unavailable;
2. The second scenario is where the communication channel 120 between the primary and secondary control apparatus 200 is unavailable.

As mentioned above, it is preferable that the wearable device operates only one radio transceiver at any one time, or does so for as long as possible, to minimise power consumption. In the slave status of the device, the processor is configured to operate the first communication device 410 substantially continuously. The second communication device 420 is only operated under particular conditions as will be discussed below.

In some embodiments, each wearable device 400 is configured to determine the availability of the first communication channel 110 with the primary control apparatus. The availability is determinable, for example, by the processor of one or more wearable devices monitoring for a periodic signal sent from the primary control apparatus as described above. Other determinations are possible, including the processor of each wearable device operating to send a signal to the primary control apparatus, and the primary control apparatus configured to send a signal in response which verifies the channel availability. However, as the minimisation of power consumption within the wearable device is important, it is most often preferable that the wearable device is configured to receive data, rather than transmit data, in order to undertake any such determinations.

When the channel is determined unavailable, the processor of one or more wearable devices 400 is configured to selectively operate the second communication device 420 instead of, or together with the first communication device 410. It is preferable that the second communication device 420 is operated only periodically. When operated, the first operation of the second communication device 420 of each wearable device 400 is to search for an attempt to connect with a secondary control apparatus 200.

In some exemplary embodiments, the processor of each wearable device 400 is configured to operate the second communications device 420 in response to:
A determination that a number of wearable devices, in a group of wearable devices, or some threshold has been met, and has lost availability of the channel 110 to communicate with the primary control apparatus 100. In some embodiments, the number is 50% or more of wearable devices, in a group of wearable devices; and/or
A determination that at least one wearable device, in a group of wearable devices, has has lost the connection 110 with the primary control apparatus 100;

Such determinations are facilitated by communication between wearable devices using the first communications device 410 of each wearable device 400. The communication could include any information, such as the status of each device, number of wearable devices in a group, data identifying each individual wearable device, and whether a communication link with the primary control apparatus is available.

When the processor of each wearable device 400 operates the second communication device 420, the first control task is to attempt connection with a secondary control apparatus 200. The first wearable device to connect with a secondary control apparatus 200 is configured as a master status device. The master status device is configured to communicate to other wearable devices, using the first communications device 410, to relay information including guidance information received from the secondary control apparatus 200, and device status information including the master device status. Accordingly, in some embodiments, wearable devices 400 with a slave device status are configured to receive data, including guidance information, from a wearable device with a master device status.

Accordingly, in another embodiment, the wearable devices comprise a control strategy for allowing connection to the secondary control apparatus 200 when the secondary to primary channel 120 is unavailable. In some circumstances, the secondary control apparatus 200 is unable to communicate with the primary control apparatus 100 via the communication channel 120 due to, for example, unavailable internet or cellular connection facilitating said channel. In this scenario, the primary control apparatus may or may not have connection with any wearable devices and as such, the availability of the first communication channel 110 is unimportant.

In some embodiments, the wearable device 400 is configured to periodically activate the onboard second communication device 420. For example, to activate the device 420 for about two minutes every hour, or as appropriate. In some embodiments, the particular time of activation for each wearable device commences randomly, or pseudo randomly. In some embodiments, the activation time of one wearable device is communicated to other wearable devices such that a sequence of activations is facilitated. In some embodiments, the wearable devices are configured to communicate one or more device parameters, such as available battery power, and the wearable device, or devices, with the most battery power are configured to activate the second communication device 420. Combinations of these power management strategies are also possible, such as the randomised activation of only a selection of wearable devices in a group of wearable devices.

In this way, when the wearable device is in a group of wearable devices, it is likely that one of the wearable devices will be activating the second communication device 420 sometime soon. In this embodiment, the secondary control apparatus 200, in proximal range, is able to search for any available wearable device which has activated the second communication device and make a connection. Once a connection has been made between the secondary control apparatus 200 and a wearable device, that wearable device is able to be configured as a master status device and communicate that status, and any guidance information, to other wearable devices as outlined with reference to FIG. 6.

This scenario offers a particular power consumption advantage whereby not all wearable devices are required to operate the second communication device for very long, and/or the additional power consumption is targeted at wearable device(s) with the most available battery power. Therefore, it is probable that only some wearable devices will operate the second communication device before a connection is made and one wearable device is configured as a master device. Further, it is probable that only wearable devices with relatively greater power available will undergo additional operation.

In some embodiments, the secondary control apparatus 200 is configured to connect with one wearable device according to the above procedures. The secondary control device is further configured to receive wearable device information including the available battery power onboard the wearable device, and other wearable devices. Accordingly, any slave status wearable devices are configured to transmit battery power information via the first communication device 410 to the master status wearable device. The secondary control apparatus 200 may then identify from the received battery power information which wearable device, in a group of wearable devices, has the most battery power available. In some embodiments, the secondary control apparatus 200 is configured to set the identified wearable device as the master status device, and that master status device, or any previous mater status device, is to communicate to all other wearable devices a slave status setting. In this way, the wearable device with the most available battery power is configured to operate both the first and second communication devices to facilitate communication between the secondary control apparatus 200 and other wearable devices as it is the most suitable to undertake the additional power consumption burden.

In some embodiments, the wearable devices are configured to periodically activate the second communication device with a duty cycle based on the available battery power. For example, wearable devices with a high battery power are configured to activate the second communication device 420 more often, and/or for longer, than devices with a lower battery power.

In some embodiments, other criteria may be used instead of or as well as the available power data to determine which wearable device should be a master status device. Other criteria include the wearable device which is in communication with the most number of other wearable devices. For example, for a large geographical area, it may be preferable to relay guidance information further than may otherwise be communicable. Accordingly, in some embodiments, the wearable device is configured to send identification information to other wearable devices, and to receive and store identification information from other wearable devices. In some embodiments, the transmission of identification information occurs periodically, such as once every hour, or day as may be appropriate for geographical migration of animals in the area.

In some embodiments, the secondary control apparatus 200 is configured to disconnect from the master status wearable device, automatically or as desired. In either case, any wearable device 400 is configured to receive an instruction to disconnect from any available second channel 130 and perform any one or more of the following control tasks:
Disconnect from communication with the secondary control apparatus 200;
Change from master to slave status;
Implement any active searching for any available second communication channel according to any strategy discussed above;
Disable further active searching for any available second communication channel;
Resume communication with the first communication channel.

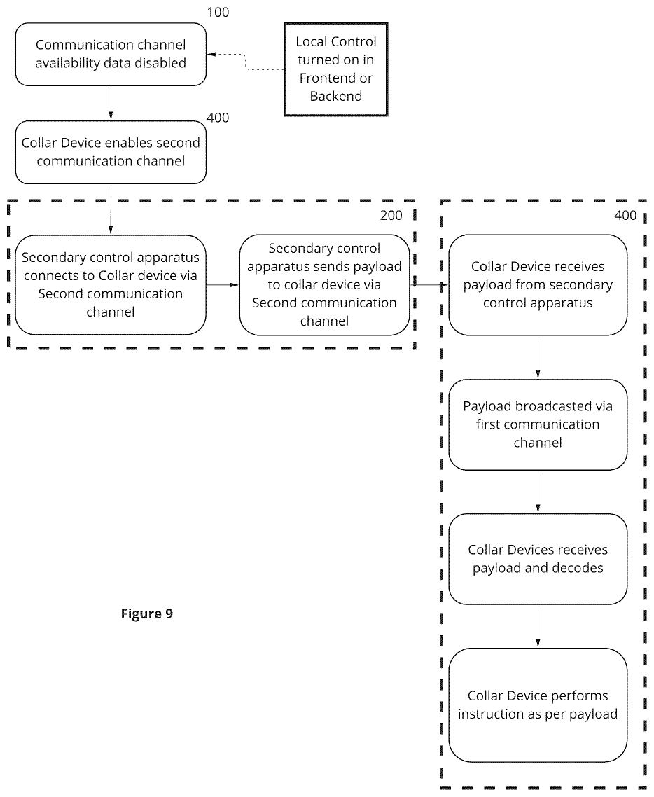

FIGS. 9-13 show process diagrams of working examples of system operation.

In these examples, the following terminology is used: The primary control apparatus 100 is referred to as a backend and gateway. The gateway comprises a LoRa transceiver system. The secondary control apparatus 200 is referred to as the frontend and is facilitated by a smartphone device which incorporates Bluetooth communications which facilitates the second communication channel 120 and cellular communications which facilitates the third communication channel 130. The first communication channel is implemented by a LoRa long range UHF radio network.

In these examples, a farmer is operating the secondary control apparatus 200 to communicate guidance information to animals adorned with wearable devices 400 also described as a collar device 400. The particular guidance information relates to the location of the animals in a virtual fencing environment. Heartbeats refers to a communication channel availability, where a heartbeat on the channel is a signal on the channel which indicates to each wearable device that the channel to the back end is available. Heartbeats and communication channel availability may refer to the availability status of a communication channel. In the foregoing examples, the wearable devices are collars worn around the neck of a cow. Local control refers to the communication between the secondary control device 200 and one or more wearable devices 400 or collars.

Referring to FIG. 9, the following control steps are outlined with reference to the primary control apparatus 100, the secondary control apparatus 200, and wearable devices 400. FIG. 9 shows an example of general use of the invention.
Local Control turned on in Frontend 200 or Backend 100. Doing so in the frontend or backend is discussed prior in the Setting device status-manual or auto.
Once local control is enabled, the Communication channel availability data is disabled.
If the collar device 400 determines that there is no Communication channel availability data, the collar device 400 enables a second communication channel.

Occurring at secondary control apparatus 200:
The secondary control apparatus 200 sends a payload (also known as the animal guidance information) to the collar device 400 via the Second communication channel. The payload will be guidance information as described herein, and will be determined by the user or prior settings.

### Occurring at Collar Device 400

The collar device 400 receives the payload from the secondary control apparatus 200, via the second communication channel.
The secondary control apparatus 200 connects to collar device 400 via Second communication channel.
Payload broadcasted via the first communication channel from the secondary control apparatus 200 to the collar device 400.
The collar device 400 receives payload and decodes.
The collar device 400 performs guidance instructions as per payload.

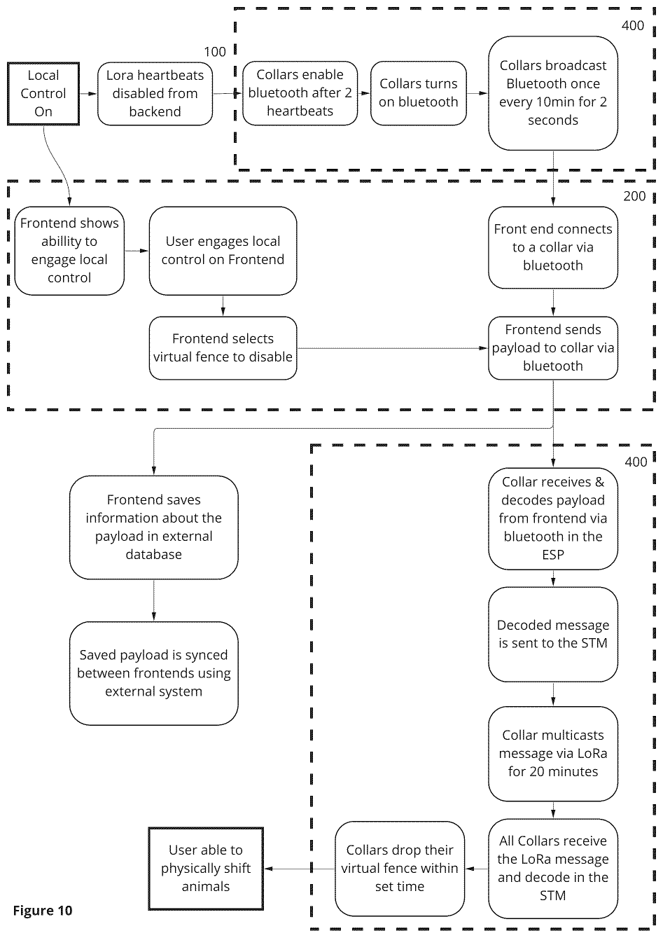

Referring to FIG. 10, the following control steps are outlined with reference to the primary control apparatus 100, the secondary control apparatus 200, and wearable devices 400. FIG. 10 shows a particular use case and particular embodiment of the general flow of FIG. 9.
Local Control is enabled either from the frontend 200, backend 100 or by the collar 400.
In this embodiment, the LoRa heartbeats are disabled (either on purpose or by malfunction) from the backend 100.

Occurring at the collar 400:
After not receiving a heartbeat, the collar devices 400 start listening for Bluetooth broadcasts. In one embodiment, the collar devices 400 enables Bluetooth after two heartbeats are not received.
The collar devices listen and/or broadcast Bluetooth once every 10 minutes for 2 seconds. This short broadcast time reduces power.

Occurring at the frontend 200:
Once local control is enabled at the backend 100, the front end then shows the ability for the user to enable local control on the frontend 200.
The user enables local control and selects the desired payload to send to the collar device 400. The payload, for example, has instructions to disable the current command (e.g. drop a virtual fence) and a set time to do so.
Meanwhile, the front end is connected to the collar device 400 via Bluetooth.
The frontend 200 sends the payload to collar device 400 via Bluetooth. The collar device 400 and the frontend must stay connected during this phase.
The collar device 400 receives & decodes payload from the frontend via Bluetooth in the collar controller, in this embodiment an ESP chip.
The decoded payload/message is sent from the ESP to an STM chip located on the collar device 400.
Off the collar: The frontend 200 saves information about the payload in an external database. This saved disablement is synced between frontends using an external system.
The collar device 400 multicasts the message via LoRa for 20 minutes.
All collar devices 400 within range receive the LoRa message and decode it in their respective STM.
The collar devices 400 perform the message, i.e disable or ‘drop’ their virtual fence within the set time.
The user is now able to physically shift animals past the virtual fence without the collar device attempting to retain the animals within the now dropped virtual fence.

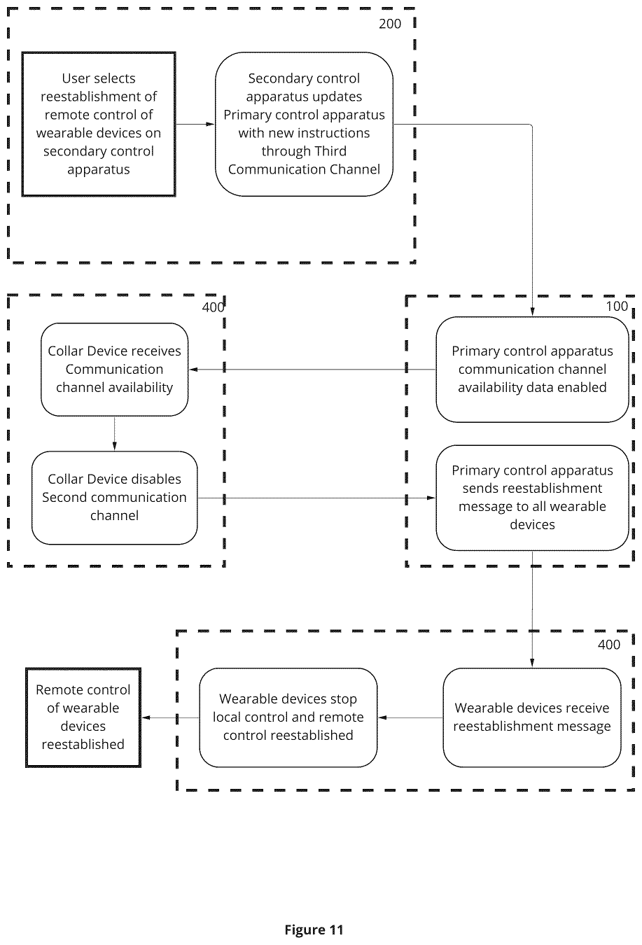

Referring to FIG. 11, the following control steps are outlined with reference to the primary control apparatus 100, the secondary control apparatus 200, and wearable devices 400. FIG. 11 shows an example of the general use of the invention to disable local control and reestablish remote control.

On the secondary control apparatus 200:
The user selects to reestablish remote control of the collar devices 400 on the secondary control apparatus 200.
The secondary control apparatus 200 updates the primary control apparatus 100 with new instructions through the third Communication Channel. The third communication channel may be cellular protocols.
The primary control apparatus 100 communication channel availability data is enabled

On the collar:
The collar device 400 receives the communication channel availability. In other embodiments, the communication channel availability may continue the entire time through local control. However, in embodiments where the collar devices 400 are configured to switch to local control when the primary control apparatus 100 communication channel availability data is lost, then communication channel availability data will determine whether local control or remote control is enabled.
The collar device 400 disables the second communication channel.
The Primary control apparatus sends a message, preferably a multicast message to all wearable devices to reestablish remote control, and/or sends all wearable devices a new instruction, payload or message.

Wearable devices receive the re-enablement message through the first communication channel
Collars Devices 400 enable and/or performs the instruction, payload or message.
Local Control Stopped

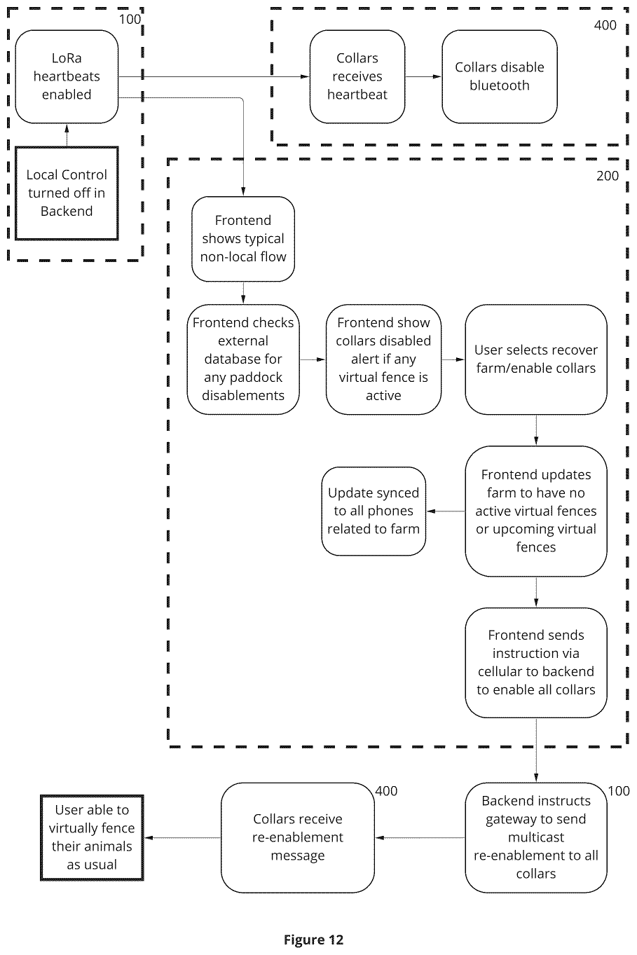

Referring to FIG. 12, the following control steps are outlined with reference to the primary control apparatus 100, the secondary control apparatus 200, and the wearable devices 400. This flow of control steps shows a recovery flow to re-establish remote control of the wearable devices 400. This would occur after local control of the wearable devices 400 was enabled and now local control is to be turned off, and remote control once again re-established.
Local Control is turned off, and in this example it is turned off from the backend 100. This may occur automatically by the gateway coming online, or by a user choosing to turn off local control via the frontend 200 or backend 100. Once local control is disestablished, LoRa heartbeats are enabled from the backend 100;
Collars 400 receive the heartbeat from the primary communication channel, i.e the gateway.
Once each collar receives a heartbeat (or multiple) they are configured to disable Bluetooth. Alternatively, Bluetooth is disabled by default on power up when a heartbeat is present;
The frontend shows a typical non-local flow of command operations to the user;
Frontend checks an external database for any virtual boundary disablements;
Frontend show collars disabled alert if any virtual fence is active;
User selects recover farm/enable collars to reestablish remote control;
Frontend updates farm to have no active virtual fences or upcoming virtual fences;
The updates are synced to all phones related to farm;
The frontend sends instruction via cellular to backend to enable all collars;
Backend instructs gateway to send multicast via LoRa or like protocol;
Re-enablement message sent to all collar devices;
The collars receive a re-enablement message and they re-establish remote control.
The user is now able to virtually fence animals wearing said collar devices by transmission of guidance information to collars using the front end and the primary communication channel.

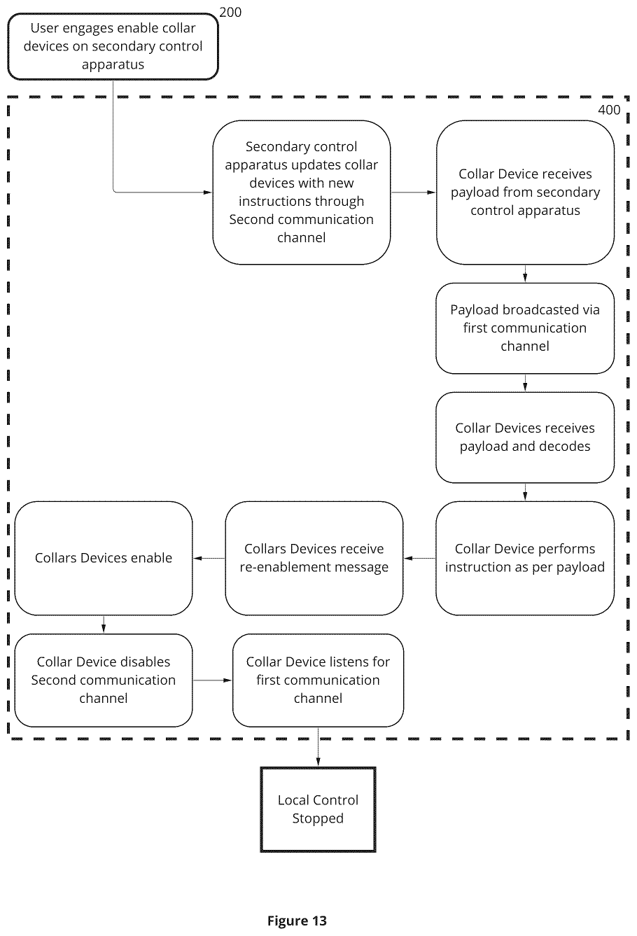

Referring to FIG. 13, the following control steps are outlined with reference to the primary control apparatus 100, the secondary control apparatus 200, and wearable devices 400. This flow of control steps shows a recovery flow to re-establish remote control of the wearable devices 400. This would occur after local control of the wearable devices 400 was enabled and now local control is to be turned off, and remote control once again re-established. In this embodiment, remote control is re-established via the secondary control apparatus, and not via the primary control apparatus.
User selects enable collar devices 400 on secondary control apparatus 200
Secondary control apparatus 200 updates collar devices 400 with new instructions through a second communication channel
Collar device 400 receives payload from secondary control apparatus 200.
Payload broadcasted by collar device 400 via first communication channel.
Collar devices 400 receive payload and decodes.
Collars Devices receive re-enablement message.
Collar devices 400 performs instruction as per payload.
Collars Devices enable.
Collar devices 400 disables the second communication channel.
Collar devices 400 enables and listens for the first communication channel.
Local Control Stopped.

Herein the working examples are related to cattle farming where the devices are wearable devices for cattle. However, there are many other uses for this technology. For example, where there are sensors (devices) that communicate with a backend (primary control apparatus), and local control directly to the devices is required. For example, sensors that sense environmental changes like those in forestry or agriculture may be controlled locally with a smartphone to download data from the sensors, or instruct the sensors to perform different tasks when typically said sensors communicate with a LoRa gateway or similar that is no longer available, or undesirable to be used.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

1. A system comprising:
a first control apparatus configured to operate at least a first communication channel to send and receive animal guidance information;
a secondary control apparatus configured to operate at least a second communication channel to send and receive animal guidance information;
a wearable device comprising:
one or more electronic devices configured to operate at least one function of the wearable device;
a first communication device configured for use with the first communication channel to receive and transmit animal guidance information;
a second communication device configured for use with the second communication channel to receive animal guidance information;
a processor configured to:
a. selectively operate at least the second communication device;
b. determine an availability status of the first communication channel, and
i. when available: operate only the first communication device to receive animal guidance information from the first control apparatus; and
ii. when not available: operate the second communication device to receive animal guidance information from the secondary control apparatus and if the second communication device receives animal guidance information from the secondary control apparatus, operate the first communication device to transmit the animal guidance information received from the secondary control apparatus to another wearable device;
c. determine receipt of animal guidance information from another wearable device on the first communication channel, and operate only the first communication device to receive animal guidance information; and
d. selectively operate the one or more electronic devices based on the received animal guidance information.

2. The system as claimed in claim 1, wherein the system further comprises a plurality of wearable devices, wherein each wearable device comprises status data indicative of:
a first status wherein the processor is configured to:
receive animal guidance information from the second communication device; and
operate the first communication device to transmit the animal guidance information received from the second communication device to another wearable device;
a second status wherein the processor is configured to:
receive animal guidance information from:
a wearable device having a first status; and/or
the first control apparatus.

3. The system as claimed in claim 1, wherein the processor is configured to selectively operate the second communication device according to an operational duty cycle based on the determination of the first communication channel being unavailable.

4. The system as claimed in claim 2, wherein the operational duty cycle comprises a period of time where the second communication device is active, and a longer period of time where the second communication device is inactive.

5. The system as claimed in claim 2, wherein the status data is configured by the first control apparatus, secondary control apparatus, and/or a wearable device from the plurality of wearable devices.

6. The system as claimed in claim 2, wherein the status data of a wearable device is configured as the first status, from the plurality of wearable devices, based on one or more of:
the wearable device having a battery power surplus;
the wearable device in a geographical target area;
the wearable device first to connect with the secondary control apparatus.

7. The system as claimed in claim 1, wherein the wearable device is configured to virtually fence an animal wearing the wearable device.

8. The system as claimed in claim 7, wherein the animal guidance information affects a function of the wearable device and comprises one or more of:
disabling the wearable device from applying stimulus to the animal;
enabling the wearable device to apply a stimulus to the animal;
cancelling a virtual fence boundary;
setting a virtual fence boundary;
shifting the animal or herd, via applying one or more stimuli to one or more animals;
setting future virtual fences for the herd or animal to be shifted to;
drafting the animal from the herd;
enabling data recording;
disabling data recording;
turning off the wearable device;
turning on the wearable device;
lighting an LED on the wearable device;
playing a sound or particular stimulus on the the wearable device;
requesting upload from the wearable device of particular animal behaviour data;
requesting recording by the wearable device of particular animal behaviour data;
applying power saving modes so the wearable device uses less power;
full local control from the secondary control apparatus and guidance
of a herd of animals, and/or
of the animal;
guiding of a herd animals or the animal to follow a location of the secondary control apparatus;
firmware updates or changes to a control function or operation of any electronic devices housed or comprised by the wearable device; and/or
bit masking information.

9. The system as claimed in claim 2, wherein the plurality of wearable devices are configured to operate the first and/or second communications device to facilitate a communication channel with one or more other wearables devices and thereby form a mesh network.

10. The system as claimed in claim 2, wherein the processor configures the wearable device as a second status device if the processor cannot receive animal guidance information from the first control apparatus or secondary control apparatus.

11. The system as claimed in claim 2, wherein the processor configures the wearable device as a second status device if the processor receives animal guidance information from another wearable device.

12. A wearable device comprising:
one or more electronic devices configured to operate at least one function of the wearable device;
a first communication device configured to communicate with a first control apparatus via a first communication channel to send and receive animal guidance information;
a second communication device configured to communicate with a secondary control apparatus via a second communication channel to send and receive animal guidance information;
a processor configured to:
selectively operate at least the second communication device;
determine an availability status of the first communication channel, and
when available: operate the first communication device to send or receive animal guidance information from the first control apparatus; and
when not available: operate the second communication device to send or receive animal guidance information from the secondary control apparatus; and
selectively operate the one or more electronic devices based on the received animal guidance information.

13. The wearable device as claimed in claim 12, wherein the wearable device further comprises status data indicative of:
a first status wherein the processor is configured to:
receive animal guidance information from the second communication device; and
operate the first communication device to transmit the animal guidance information received from the second communication device to another wearable device;
a second status wherein the processor is configured to:
receive animal guidance information from:
a wearable device having a first status; and/or
the first control apparatus.

14. The wearable device as claimed in claim 12, wherein the wearable device is configured to virtually fence an animal wearing the wearable device.

15. The wearable device as claimed in claim 14, wherein the animal guidance information affects a function of the wearable device, the function comprising one or more of:
disabling wearable device(s) from applying stimulus to the animal;
enabling wearable device(s) so they can apply a stimulus to the animal;
cancelling a virtual fence boundary;
setting a (virtual fence boundary;
shifting the animal or herd, via applying one or more stimuli to one or more animals;
setting future virtual fences for the herd or animal to be shifted to;
drafting the animal from the herd;
enabling data recording;
disabling data recording;
turning off the wearable device;
turning on the wearable device;
lighting an LED on the wearable device;
playing a sound or particular stimulus on the wearable device;
requesting upload from the wearable device of particular animal behaviour data;
requesting recording by the wearable device of particular animal behaviour data;
applying power saving modes so the wearable device uses less power;
local control and guidance
of a herd of animals, and/or
of the individual animal;
guiding of a herd of animals or the animal to follow a location of the secondary control apparatus;
firmware updates or changes to a control function or operation of any electronic devices housed or comprised by the wearable device; and/or
bit masking information.

16. The wearable device as claimed in claim 12, wherein the wearable device is configured to operate the first and/or second communications device to facilitate a communication channel with one or more other wearables devices and thereby form a mesh network.

17. The wearable device as claimed in claim 16, wherein the mesh network is configured to receive the animal guidance information via either the first control apparatus or secondary control apparatus.

18. The wearable device as claimed in claim 13, wherein the processor is configured to:
determine whether animal guidance information is received from the first control apparatus or secondary control apparatus, and, if not:
configure the wearable device as a second status device.

19. The wearable device as claimed in claim 13, wherein the processor is configured to:
receive animal guidance information from another wearable device, and in response, configure the wearable device as a second status device.

20. The wearable device as claimed in claim 13, wherein the first status wearable device is distinguished from a second status wearable device based on one or more one or more characteristics of the first status wearable device, comprising:
a battery power surplus; and
a location in a geographical target area.
